(19) United States
(12) Patent Application Publication
(10) Pub. No.: US 2007/0226416 A1
(43) Pub. Date: Sep. 27, 2007

(54) Portable random access memory

(76) Inventor: Cheng Yi-Ching, Taichung City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/370,901

(22) Filed: Mar. 9, 2006

(51) Int. Cl. G06F 12/00

(52) U.S. Cl. 711/115; 711/103

(57) ABSTRACT

Disclosed is a portable random access memory (PRAM) with a data card body involving at least one installation space for housing a NOR type flash memory IC chip; and electrically conductive data transmission entity contained in the data card body and having a data transmission conductor extended to the installation space; and a control chip intercalated between the data transmission conductor and the data transmission entity for controlling connection state between the NOR type flash memory chip and the external circuit so as to check if the data stored in the NOR type flash memory chip can be outputted. Such PRAM is available for storing and reading out user's newest private information such as the financial and health condition, clinic resume record, freeway toll system, or vehicle engine trouble shooting record etc. in a very short time so as to avoid needs for re-establishment of the data.

### BACKGROUND OF THE INVENTION

1. Field of the Invention

The present invention relates to a portable random access memory, and more particularly, to a portable random access memory (PRAM) in which a plurality of NOR flash memories or other non NAND flash access memories are employed to provide newest data in an environment where the required storing capacity is not high but demanding a rapid random access speed so as to save time for re-understanding or retesting to recover previous data.

2. Description of the Prior Art

Keeping in pace with the rapid progress of science, the development of computer technology and electronic products has also made an amazing innovation. Among which the memory card has become the most convenient data storing device. The application field of the memory card is so wide as to cover the digital camera, digital video and other high technological products.

There are many kinds of memory cards including SD, XD, MMC that have evolved according to different memory cells. The essential function of a memory card is to store data through built in memory element, and transmit its information to a card reader from its external terminal, and finally received by the computer main frame.

The traditional memory card is essentially equipped with contact terminals (generally by the name of golden fingers) in the position on its main body corresponding to an adapter. When the main body of the memory card is inserted into the adapter, the contact terminal of the memory card main body is engaged with the contact blade within the adapter in up and down superposing manner so that the memory card may be in connection with the readout device via the adapter thereby enabling reading out or storing the data.

In the present market, the flash memory cards are classified in five categories, i.e. compact flash (CF) card, smart media card (SMC), multimedia card (MMC), secure digital (SD) card, and memory stick (MS) card.

Owing to the fact that they all belong to a NAND flash chip, it is suited for high capacity data storing but requiring a long random access time. Accordingly, it is inconvenient to use it in a working condition where it is needed to read out data in a short time. On the contrary, the low capacity yet with rapid readable feature, the NOR type flash chips are only used to store the program or a little amount of data, and are all fixedly welded to an electrical board. Really, it is a silly matter.

Take vehicle engine trouble shooting for example, all the average high class cars has a non-portable NOR type flash memory card chip welded on the electric circuit board such that a bulk special computer in necessary to read out the data for making a diagnosis. As a matter of fact, if a portable storing device capable of reading out the data rapidly, the car owner may only bring the portable storing device, but not drive the car itself to the repair workshop thereby able to save time and labor.

Take a privy sanitary closestool as another example, usually there is provided a control button capable of setting a water spray speed, aimed position, and temperature in match with the individual needs. In case the closestool is not for private use, the above data has to be reset every time the closestool is replaced. This is bothersome to the user. If a portable storing device with rapidly readable feature can be provided to insert into an insertion read box for reset, it will be time saving.

It is what the reason the present inventor has endeavored for years by continuous research and experimentation attempting to discover the remedy to rectify the inherent inconvenience of the conventional techniques described above, and finally has come out with the present invention.

### SUMMARY OF THE INVENTION

Accordingly, it is an object of the present invention to provide a portable random access memory (PRAM) in which NOR type flash memories are used as chips for storing or reading out data and display in a short time.

It is another object of the present invention to make the PRAM available for storing and readout information concerning the private financial condition or private health record and clinical resume so as to eliminate repeated verbosity of restudy or reexamination carried out in the next case or at another medical organization thereby saving unnecessary annoyance.

It is one more object of the present invention to make the PRAM available for storing and reading out information concerning the private financial condition or private health record and clinical resume so as to eliminate repeated verbosity of restudy or reexamination carried out in the next case or at another medical organization thereby saving unnecessary annoyance.

It is one more object of the present invention to make the PRAM applicable for storing and reading out information related to freeway toll system, vehicle engine trouble shooting, sanitary closestool operation, and other miscellaneous livelihood facilities in the most efficient way so as to save repeated reinput or reset of the necessary data by the user.

### BRIEF DESCRIPTION OF THE DRAWINGS

The present invention may best be understood through the following description with reference to the accompanying drawings, in which:

FIG. 1 is a schematic view of the PRAM of the present invention;

FIG. 2 is an illustrative block diagram in an embodiment of the present invention; and,

FIG. 3 is another illustrative block diagram in another embodiment of the present invention.

### DETAILED DESCRIPTION OF THE PREFERRED EMBODIMENT

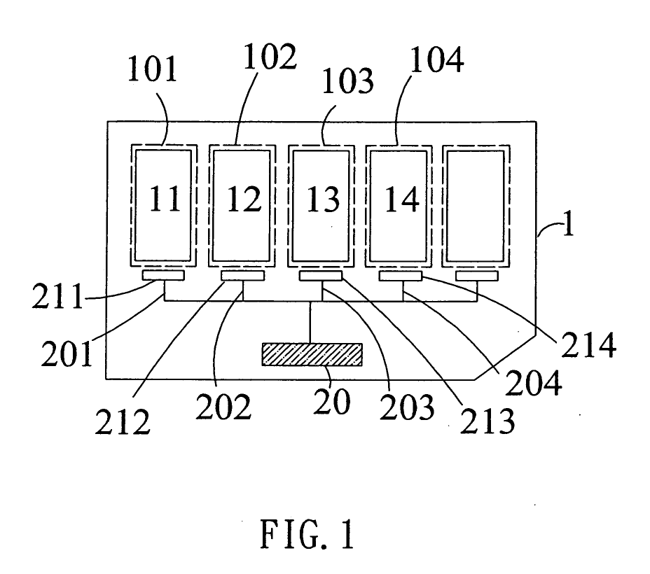

FIG. 1 shows the schematic view of the PRAM according to the present invention. The PRAM has a data card body 1 involving more than one installation spaces 101, 102, 103, 104, . . . for housing NOR type flash memory IC chips 11, 12, 13, 14 . . . . The card body 1 also contains an electrically conductive data transmission entity 20 from which conductors 201, 202, 203, 204, . . . are extended to the installation spaces 101, 102, 103, 104, . . . for connection with the corresponding NOR type flash memory IC chips so as to input or reading respective data. Control chips 211, 212, 213, 214, . . . are intercalated respectively between the data transmission entity 20 and the conductors 201, 202, . . . for controlling connection state between the NOR type flash memory chips 11, 12, 13, 14, . . . and the external circuit so as to check if the data stored in the memory chips 11, 12, 13, 14, . . . can be outputted.

By making use of the feature that the NOR flash memory can randomly read out the data, the PRAM of the present invention employs the NOR type flash memory to store small amount of data to provide newest information in a shortest time for various working conditions.

The PRAM of the present invention is widely applicable to all ordinary memory cards and their associated interfaces obtainable from the present market without limiting to particular storage formats or standards.

The applicable fields of the PRAM according to the present invention are enumerated as follows, but it should not be construed that the scope of application is limited only as such:
1. freeway toll system;
2. vehicle engine trouble shooting;
3. private financial information including consumer's record;
4. private health care and clinic resume record;
5. access security control;
6. privy sanitary closestool control;
7. air conditioning, light, and electrical appliances control;
8. alarm setting;
9. cash card control;
10. library card control;
11. easy card control;
12. tourist and recreation card control (reservation for ticket, seat, food, etc.);
13. remote monitoring (control of electrical appliances via web);
14. global satellite positioning (personal record and vehicle information);
15. health insurance card control;
16. student school record (communication between teacher and parents);
17. Factory environment and production process control;
18. Water filter replacement and material consumption record;
19. Metering instrument control (water, electrical and gas);
20. electric massage chair control.

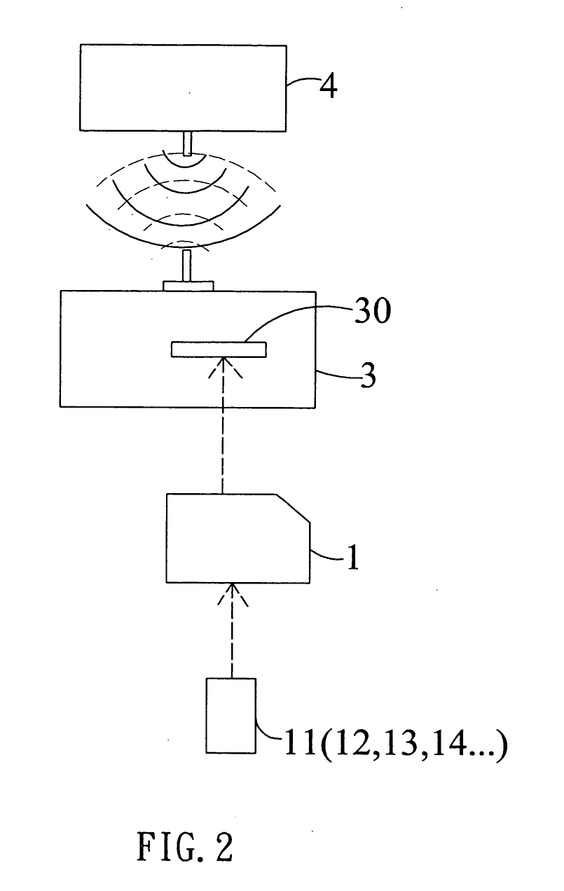

Referring to FIG. 2, in an embodiment of the present invention, various information related to the user such as those mentioned in items 1 to 20 is written into more than one flash type memory IC chips 11, 12, 13, 14 equipped on an IC data card 1; then the data stored in the data card 1 is read out by a card reader 3 by inserting the data card 1 into various card slots 30 of the card reader 3; afterwards the data read by the card reader 3 is transmitted to a control center 4 through wireless or wired transmission for processing; the data being processed is sent back to the card reader 3 so as to store the newest data such as date, cash balance etc. in the data card 1. After completion of treatment, the data card 1 stored with the new data is returned to the hand of the user.

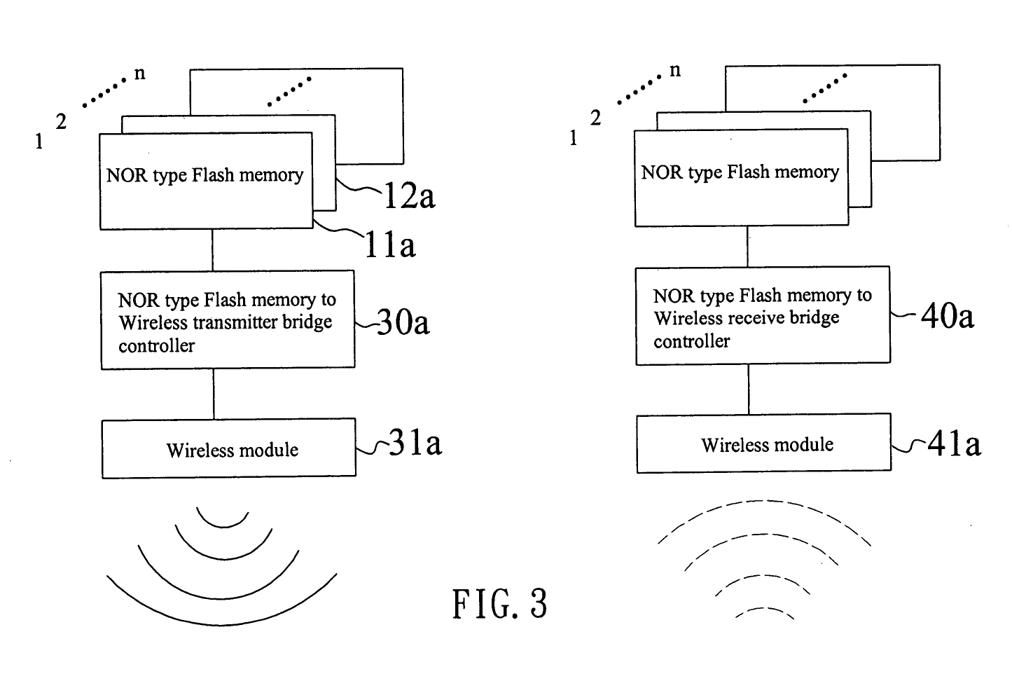

Referring to FIG. 3, in another embodiment, the NOR type flash memory chips 11a, 12a, . . . are provided with a NOR type flash memory to wireless transmitter bridge controller 30a and a wireless module 31a for transmitting the user's data stored in the data card 1, and also provided with a NOR type flash memory to wireless receiver bridge controller 40a and a wireless module 41a for receiving the data coming in from outside to a treatment center for processing. After treatment, the data is sent back to be stored in the chips 11a, 12a, . . . as the user's renewed information.

In the above two embodiments, the wireless transmitter bridge controller 30a, the wireless receiver bridge controller 40a, and the wireless modules 31a and 41a can be equipped with the IC data card, or equipped with the card reader and the data processing center respectively. Besides, the data card can be formed functionable as the wireless transmitter bridge controller and the wireless receiver bridge controller.

Although the invention has been described in terms of preferred embodiments, it is apparent that numerous variations and modifications may be made without departing from the true spirit and scope thereof, as set forth in the following claims.

What is claimed is:

1. A portable random access memory (PRAM) with a data card body involving at least one installation space for housing a NOR type flash memory IC chip; an electrically conductive data transmission entity contained in said data card body and having a data transmission conductor extended to said installation space; and a control chip intercalated between said data transmission conductor and said data transmission entity for controlling connection state between said NOR type flash memory chip and the external circuit so as to check if the data stored in said NOR type flash memory chip can be outputted.

2. The PRAM as in claim 1, wherein said data card employing said NOR type flash memory is applicable as a readout device for the freeway toll system information.

3. The PRAM as in claim 1, wherein said data card employing said NOR type flash memory is applicable as a readout device for vehicle engine trouble shooting.

4. The PRAM as in claim 1, wherein said data card employing said NOR type flash memory is applicable as a readout device for private financial planning information and clinic resume record.

5. A PRAM having a structure including a housing and an electrical circuit board; said electrical circuit board being equipped with a control unit, data readout unit, and data storing unit; and a data transmission terminal formed on one end of said housing; wherein said PRAM employs a NOR type flash memory.

6. A PRAM having an insertion structure which being composed of a housing with one end formed into a data transmission terminal; an interface, and an electrical circuit board equipped with a memory for readout and storing data; wherein the insertion data card used by said PRAM is a NOR type flash memory.

7. The PRAM as in claim 6, wherein said data card employing said NOR type flash memory is applicable as a readout device for the freeway toll system information.

8. The PRAM as in claim 6, wherein said data card employing said NOR type flash memory is applicable as a readout device for vehicle engine trouble shooting.

9. The PRAM as in claim 6, wherein said data card employing said NOR type flash memory is applicable as a readout device for private financial planning information and clinic record.

10. A PRAM having an insertion structure which being composed of a housing, an interface, and an electrical circuit board, wherein said electrical circuit board is equipped with a memory for reading and storing.

11. The PRAM as in claim 1, wherein said data card employing said NOR type flash memory is provided with a NOR type flash memory to wireless transmitter bridge controller and a wireless module for transmitting the user's data stored in said data card.

12. The PRAM as in claim 1, wherein said data card employing said NOR type flash memory is provided with a NOR type flash memory to wireless receiver bridge controller and a wireless module for receiving the coming in data from outside to read in said NOR type flash memory.

13. The PRAM as in claim 12, wherein said data card employing said NOR type flash memory is provided with a NOR type flash memory wireless transmitter/receiver bridge controller and a wireless module for transmitting/receiving user's information.

14. The PRAM as in claim 5, wherein said electrical circuit board is provided with a NOR type flash memory to wireless transmitting bridge controller and a wireless module.

15. The PRAM as in claim 6, wherein said electrical circuit board is equipped with a NOR type flash memory to wireless receiver bridge controller and a wireless module.

16. The PRAM as in claim 10, wherein said electrical circuit board is equipped with a NOR type flash memory to wireless receiver bridge controller and a wireless module.
